(19) United States
(12) Patent Application Publication
(10) Pub. No.: US 2013/0222226 A1
(43) Pub. Date: Aug. 29, 2013

(54) USER INTERFACES AND ASSOCIATED APPARATUS AND METHODS

(71) Applicant: Michiel TERLOUW, Helsinki (FI)

(72) Inventor: Michiel TERLOUW, Helsinki (FI)

(73) Assignee: NOKIA CORPORATION, Espoo (FI)

(21) Appl. No.: 13/404,375

(22) Filed: Feb. 24, 2012

(51) Int. Cl. G09G 5/00

(52) U.S. Cl. 345/156

(57) ABSTRACT

An apparatus including at least one processor; and at least one memory including computer program code, the at least one memory and the computer program code configured to, with the at least one processor, cause the apparatus to perform at least the following: in response to detecting a particular non-selecting user input spatially associated with a tactile user interface of an electronic device, provide for changing a region of the tactile user interface from a first configuration to a second configuration, the tactile user interface region comprising one or more user interface elements, wherein when the tactile user interface region is in the second configuration, the user interface elements of the tactile user interface region have a different depth aspect than when the tactile user interface region is in the first configuration.

### TECHNICAL FIELD

The present disclosure relates to the field of user interfaces, associated methods, computer programs and apparatus. Certain disclosed aspects/embodiments relate to portable electronic devices, in particular, so-called hand-portable electronic devices which may be hand-held in use (although they may be placed in a cradle in use). Such hand-portable electronic devices include so-called Personal Digital Assistants (PDAs) and tablet personal computers.

The portable electronic devices/apparatus according to one or more disclosed aspects/embodiments may provide one or more audio/text/video communication functions (e.g. tele-communication, video-communication, and/or text transmission (Short Message Service (SMS)/Multimedia Message Service (MMS)/emailing) functions), interactive/non-interactive viewing functions (e.g. web-browsing, navigation, TV/program viewing functions), music recording/playing functions (e.g. MP3 or other format and/or (FM/AM) radio broadcast recording/playing), downloading/sending of data functions, image capture function (e.g. using a (e.g. in-built) digital camera), and gaming functions.

### BACKGROUND

It is common for electronic devices to provide a user interface (e.g. a graphical user interface). A user interface may enable a user to interact with an electronic device, for example, to open applications using application icons, enter commands, to select menu items from a menu, or to enter characters using a virtual keypad. The user may interact with the user interface directly (e.g. by using a stylus, such as a finger, on a touch screen) or indirectly (e.g. using a mouse to control a cursor).

The listing or discussion of a prior-published document or any background in this specification should not necessarily be taken as an acknowledgement that the document or background is part of the state of the art or is common general knowledge.

### SUMMARY

In a first aspect, there is provided an apparatus, the apparatus comprising:
at least one processor; and
at least one memory including computer program code,
the at least one memory and the computer program code configured to, with the at least one processor, cause the apparatus to perform at least the following:

in response to detecting a particular non-selecting user input spatially associated with a tactile user interface of an electronic device, provide for changing a region of the tactile user interface from a first configuration to a second configuration, wherein:

when the tactile user interface region is in the second configuration, the user interface elements of the tactile user interface region have a different depth aspect than when the tactile user interface region is in the first configuration.

It will be appreciated that providing for changing a region of the tactile user interface may comprise generating signalling which may be transmitted to the tactile user interface to engender the change in configuration.

When the tactile user interface region is in the second configuration, the user interface elements of the tactile user interface region may have a greater depth aspect than when the tactile user interface region is in the first configuration. When the tactile user interface region is in the second configuration, the user interface elements of the tactile user interface region may have a smaller depth aspect than when the tactile user interface region is in the first configuration.

When the tactile user interface region is in the first configuration, the depth aspect may be zero. That is, in the first configuration, the tactile user interface region may comprise two-dimensional user interface elements, and in the second configuration, the tactile user interface region may comprise the same one or more user interface elements in a three-dimensional configuration.

When the tactile user interface region is in the second configuration, the user interface elements of the tactile user interface region may have a greater depth aspect than when the tactile user interface region is in the first configuration. When the tactile user interface region is in the second configuration, the user interface elements of the tactile user interface region may have a smaller depth aspect than when the tactile user interface region is in the first configuration.

The depth aspect may be considered to be the depth of the user interface element above the surface (e.g. when the user interface elements are raised above the display) and/or the depth of the user interface element below the surface (e.g. when the user interface elements are recessed into the display). The depth aspect may be considered to be the position of the surface of the user interface element with respect to the electronic device. For example, a user interface element surface moves outwards or inwards with respect to the electronic device to have a different depth aspect.

It will be appreciated that the provision of changing of or the changing of a region of the tactile user interface region from a first configuration to a second configuration may allow buttons to be physically created (e.g. by popping up) on a surface in response to a particular non-selecting user input being detected (for example, the particular non-selecting user input may be a finger hovering over a touch screen tactile user interface).

Advantages of changing a region of the tactile user interface from a first configuration to a second configuration may include that a better user experience is provided. It may allow the user to have tactile feedback when selecting the three-dimensional user interface elements, which may help prevent unintended selection. It will be appreciated that, when in the configuration with a particular depth aspect (e.g. a flat, two-dimensional configuration), the user interface may look less cluttered, and have a more pleasing appearance.

In the first configuration, the user interface elements may be configured to be de-activated so as not to detect selecting user input. In the second configuration, the user interface elements may be configured to be activated so as to be able to detect selecting user input.

A tactile user interface may comprise one or more tactile user interface regions. Each particular tactile user interface region changed from a first configuration to a second configuration may correspond to a respective particular non-selecting user input. For embodiments comprising a plurality of tactile user interface regions, it will be appreciated that the tactile user interface regions may be mutually exclusive, contiguous and/or overlapping.

A two-dimensional user interface element may be configured to be visible to the user. For example, the two-dimensional user interface elements may be distinguished from the background using colours. A two-dimensional user interface element may be configured to be invisible to the user (or not distinguished from the background).

An input may be considered to be a gesture or user interaction which is detectable by the user interface (e.g. a button press or pressing on a touch screen). An input may comprise a combination of one or more of: a gesture interaction; a multi-touch gesture; a tap gesture; a drag gesture; a hover input (e.g. an input which is not touching a touch screen tactile user interface but detectable by the touch screen tactile user interface); a touch input; a scroll input; a key press; and a button press. A hover input may be detected at distances less than, for example, 1 cm to 4 cm from a surface of a touch screen and/or distances greater than, for example 0.1 mm from the surface of the touch screen.

A non-selecting user input may be considered to be an input which is not associated with a command relating to the content (e.g. user application, file or folder) corresponding to a user interface element. That is, a non-selecting user input may be considered to not allow the user to control a user application of the device or a function of the device. Nevertheless, a non-selecting user input may be spatially associated with a user interface element. A non-selecting user input may be a hover input (e.g. where a stylus or finger is not in contact with the tactile user interface). The non-selecting user input may be a touch input (e.g. where a stylus or finger is in contact with the tactile user interface). The non-selecting user input may be a user input provided without touching the tactile user interface. The non-selecting user input may be spatially associated with the tactile user interface by being provided by a stylus (such as a finger or other stylus) having a position corresponding to the tactile user interface.

It will be appreciated that the apparatus may be configured to, in response to detecting completion of a particular non-selecting user input spatially associated with the tactile user interface of an electronic device, provide for changing a region of the tactile user interface from a second configuration to an first configuration, wherein:
when the tactile user interface region is in the second configuration, the user interface elements of the tactile user interface region have a different depth aspect than when the tactile user interface region is in the first configuration.

It will be appreciated that this may allow physical buttons to apparently appear and disappear in response to the provision and removal of a particular non-selecting user input (e.g. where the first configuration is a two-dimensional configuration).

The apparatus may be configured to: recognise a particular user input maintained for a time period below a predetermined time threshold as a non-selecting user input; and recognise the same particular user input maintained for a time period exceeding a predetermined time threshold as a selecting user input. For example, a hover input maintained in the same position for less than 2 seconds may be recognised as a non-selecting input, but if the same hover input were maintained for over 2 seconds it would be recognised as a selecting input for the user interface element underlying the position of the user input. That is, it will be appreciated that after a predetermined time, non-selecting user input may be considered to be a selecting input for the user interface element underlying the position of the non-selecting/selecting user input.

The apparatus may be configured to change the user interface elements from the second configuration to the first configuration after a predetermined period of time if a selecting user input has not been detected for the predetermined period of time after the non-selecting user input.

The tactile user interface region may be configured to remain in the second configuration whilst the non-selecting user input is detected to be ongoing. The tactile user interface region may be configured to remain in the second configuration whilst the non-selecting user input or a subsequent selecting user input is detected to be ongoing.

The tactile user interface region may be configured to remain in the second configuration for a pre-determined period of time after detecting the non-selecting user input.

In response to not detecting a user input spatially associated with a tactile user interface, the apparatus may be configured to change a tactile user interface region from a second configuration to a first configuration.

A tactile user interface region may be configured to remain in a second configuration whilst an interaction (non-selecting/selecting) with the tactile user interface region is detected.

The tactile user interface region may be a portion of the tactile user interface having a position corresponding to the position of the non-selecting user input.

The tactile user interface may comprise a keyboard on a mobile device. The user interface elements may comprise one or more of selection buttons on a dialogs given to a user (e.g. ‘OK’ or ‘back’, or for controlling music); keys; icons; and menu items.

The apparatus may be configured such that the position of the tactile user interface region corresponds to the position of the non-selecting user input. For example, the apparatus may be configured to, in response to the position of the non-selecting user input changing, correspondingly change the position of the three-dimensional tactile user interface region. In this way, the three dimensional user interface region may be considered to follow the non-selecting user input (e.g. if the user moves his finger to the left, the user interface elements on the left are changed from a first configuration to a second configuration).

The tactile user interface may be configured to enable character entry (e.g. to enable a textual message to be composed). A textual message may comprise, for example, a combination of one or more of a text message, an SMS message, an MMS message, an email, a search entry, a text document, a twitter post, a status update, a blog post, a calendar entry and a web address. A character may comprise a combination of one or more of a word, a letter character (e.g. from the Roman, Greek, Arabic or Cyrillic alphabets), a graphic character (e.g. a sinograph, Japanese kana or Korean delineation), a phrase, a syllable, a diacritical mark, an emoticon, and a punctuation mark. A tactile user interface region may comprise a keyboard. A keyboard or keypad may comprise an alphanumeric key input area, a numeric key input area, an AZERTY key input area, a QWERTY key input area or an ITU-T E.161 key input area.

Changing a user interface element between a first configuration and a second configuration may be enabled by one or more actuators configured to change the shape of the surface of the tactile user interface. The actuator may be piezoelectric actuator. The tactile user interface may comprise deformable regions (e.g. chambers) underlying the surface (e.g. a resilient surface) which can be expanded or contracted (e.g. pneumatically, hydraulically) to change the configuration of the user interface elements between a first configuration and a second configuration. The tactile user interface may comprise an array of haptic elements which are independently movable to make shapes on the surface. The tactile user interface may be changed between a first configuration and a second configuration using electrostatic surface actuation. The tactile user interface may comprise electroactive materials (e.g. electroactive polymers). The apparatus may be configured to provide for change of the tactile user interface elements between the first configuration and the second configuration by us of one or more actuators.

The apparatus may be configured to enable detection of the particular non-selecting user input.

The apparatus may comprise one or more of the tactile user interface, the user interface elements or a display.

The tactile user interface ma form part of a display (e.g. a touch screen, a OLED (organic light emitting diode) display). The tactile user interface may not form part of a display.

The apparatus may be of form part of at least one of a portable electronic device, circuitry for a portable electronic device, a television, a tablet computer, a laptop computer, a desktop computer, a mobile phone, a Smartphone, a tablet PC, a monitor, a car entertainment system, a satellite navigation system, a car dashboard, a game controller, a remote control, a control panel (e.g. for home heating), an automated teller machine (ATM) or cash machine, a personal digital assistant, a digital camera or a module for the same.

In a second aspect, there is provided a method, the method comprising:
in response to detecting a particular non-selecting user input spatially associated with a tactile user interface of an electronic device, providing for changing a region of the tactile user interface from a first configuration to a second configuration, wherein:
when the tactile user interface region is in the second configuration, the user interface elements of the tactile user interface region have a different depth aspect than when the tactile user interface region is in the first configuration.

In a third aspect, there is provided a computer program comprising computer program code configured to:
in response to detecting a particular non-selecting user input spatially associated with a tactile user interface of an electronic device, provide for changing a region of the tactile user interface from a first configuration to a second configuration, wherein:
when the tactile user interface region is in the second configuration, the user interface elements of the tactile user interface region have a different depth aspect than when the tactile user interface region is in the first configuration.

The computer program may be stored on a storage media (e.g. on a CD, a DVD, a memory stick or other non-transitory medium). The computer program may be configured to run on a device or apparatus as an application. An application may be run by a device or apparatus via an operating system.

In a fourth aspect, there is provided an apparatus, the apparatus comprising:
means for changing configured to, in response to detecting a particular non-selecting user input spatially associated with a tactile user interface of an electronic device, provide for changing a region of the tactile user interface from a first configuration to a second configuration, wherein:
when the tactile user interface region is in the second configuration, the user interface elements of the tactile user interface region have a different depth aspect than when the tactile user interface region is in the first configuration.

The present disclosure includes one or more corresponding aspects, embodiments or features in isolation or in various combinations whether or not specifically stated (including claimed) in that combination or in isolation. Corresponding means and corresponding function units (e.g. depth aspect changer) for performing one or more of the discussed functions are also within the present disclosure.

Corresponding computer programs for implementing one or more of the methods disclosed are also within the present disclosure and encompassed by one or more of the described embodiments.

### BRIEF DESCRIPTION OF THE DRAWINGS

A description is now given, by way of example only, with reference to the accompanying drawings, in which:

FIG. 1 depicts an embodiment comprising a number of electronic components, including memory and a processor.

FIG. 2 depicts an embodiment comprising a number of electronic components, including memory, a processor and a communication unit.

FIG. 3a-3f depicts an example embodiment of FIG. 2 comprising a mobile telephone.

FIG. 4a-4h depicts a further example embodiment comprising an in-car entertainment system.

FIG. 5a-5f depicts a further example embodiment comprising an ATM (cash machine).

FIG. 6 depicts a flow diagram describing changing a tactile user interface region from a two-dimension configuration to a second configuration

FIG. 7 illustrates schematically a computer readable media providing a program according to an example embodiment.

### DETAILED DESCRIPTION

Other embodiments depicted in the figures have been provided with reference numerals that correspond to similar features of earlier described embodiments. For example, feature number 1 can also correspond to numbers 101, 201, 301 etc. These numbered features may appear in the figures but may not have been directly referred to within the description of these particular embodiments. These have still been provided in the figures to aid understanding of the further embodiments, particularly in relation to the features of similar earlier described embodiments.

It is common for an electronic device to have a user interface (which may or may not be graphically based) to allow a user to interact with the device. For example, the user may use a keyboard to enter text or icons to select and run applications. It is also common that a user interface comprises a touch screen which may be configured to provide a virtual keyboard, icons or menu items which may be selected (or otherwise interacted with) by pressing on the screen.

It may be beneficial to provide tactile feedback to the user when interacting with such touch screens as this may, for example, increase typing speed, reduce errors (e.g. through unintended selections), and/or provide better feedback to the user. It will be appreciated that providing tactile feedback may allow the user to navigate the screen without having to look at the screen. Providing user interface elements with different depth aspects may help the user use fine motor control and allow micro-adjustment of finger position (which may help the user provide fast and accurate input). Providing different configurations may also make the device more accessible to blind users.

Example embodiments contained herein may be considered to provide a way of allowing a user to change a region of a tactile user interface from a first configuration to a second configuration with a different depth aspect by providing a non-selecting user input. It will be appreciated that by creating a user interface element with a different depth, the user may be provided with visual feedback (e.g. as well as tactile feedback) which may, for example, indicate which user interface elements are available (e.g. for selection). It will be appreciated that the feedback (e.g. visual and/or tactile) may be provided in advance of the user selecting a user interface element (e.g. using a selecting user input). Providing feedback in advance of selection may reduce the number of unintended user interface element selections.

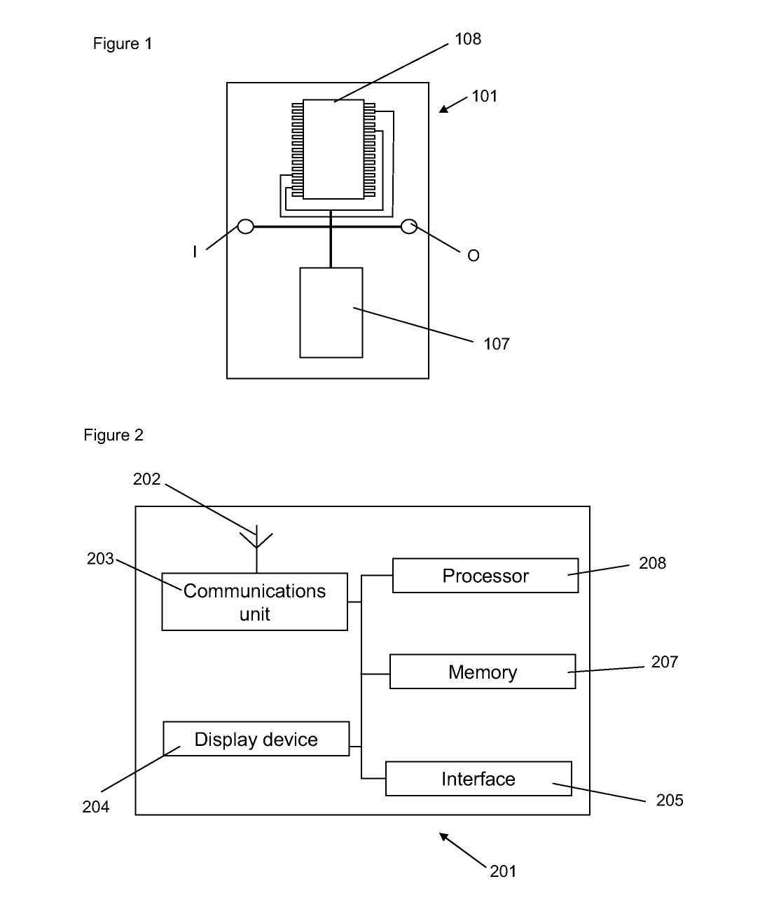

FIG. 1 shows an example embodiment of an apparatus (101) comprising memory (107), a processor (108), input I and output O. In this embodiment only one processor and one memory are shown but it will be appreciated that other embodiments may utilise more than one processor and/or more than one memory (e.g. same or different processor/memory types).

In this embodiment the apparatus (101) is an application specific integrated circuit (ASIC) for a portable electronic device with a touch sensitive display. In other embodiments the apparatus (101) can be a module for such a device, or may be the device itself, wherein the processor (108) is a general purpose CPU of the device and the memory (107) is general purpose memory comprised by the device.

The input I allows for receipt of signalling to the apparatus 101 from further components, such as components of a portable electronic device or the like. The output O allows for onward provision of signalling from within the apparatus 101 to further components. In this embodiment the input I and output O are part of a connection bus that allows for connection of the apparatus 101 to further components.

The processor 108 is a general purpose processor dedicated to executing/processing information received via the input I in accordance with instructions stored in the form of computer program code on the memory 107. The output signalling generated by such operations from the processor 108 is provided onwards to further components via the output O.

The memory 107 (not necessarily a single memory unit) is a computer readable medium (solid state memory in this example, but may be other types of memory such as a hard drive, ROM, RAM, Flash or the like) that stores computer program code. This computer program code stores instructions that are executable by the processor 108, when the program code is run on the processor 108. The internal connections between the memory 107 and the processor 108 can be understood to, in one or more embodiments, provide an active coupling between the processor 108 and the memory 107 to allow the processor 108 to access the computer program code stored on the memory 107.

In this embodiment the input I, output O, processor 108 and memory 107 are all electrically connected to one another internally to allow for electrical communication between the respective components I, O, 108, 107. In this example the components are all located proximate to one another so as to be formed together as an ASIC, in other words, so as to be integrated together as a single chip/circuit that can be installed into an electronic device. In other embodiments one or more or all of the components may be located separately from one another.

FIG. 2 depicts an apparatus (201) of a further example embodiment, such as a mobile phone. In other example embodiments, the apparatus (201) may comprise a module for a mobile phone (or PDA or audio/video player), and may just comprise a suitably configured memory (207) and processor (208).

The example embodiment of FIG. 2, in this case, comprises a display device (204) such as, for example, a Liquid Crystal Display (LCD) or touch-screen user interface. The apparatus (201) of FIG. 2 is configured such that it may receive, include, and/or otherwise access data. For example, this example embodiment (201) comprises a communications unit (203), such as a receiver, transmitter, and/or transceiver, in communication with an antenna (202) for connecting to a wireless network and/or a port (not shown) for accepting a physical connection to a network (or other input device, e.g. micro USB port), such that data may be received via one or more types of networks. This example embodiment comprises a memory (207) that stores data, possibly after being received via antenna (202) or port or after being generated at the user interface (205). The processor (208) may receive data from the user input interface (205), from the memory (207), or from the communication unit (203). It will be appreciated that, in certain example embodiments, the display device (204) may incorporate the user input interface (205). Regardless of the origin of the data, these data may be outputted to a user of apparatus (201) via the display device (204), and/or any other output devices provided with apparatus. The processor (208) may also store the data for later use in the memory (207). The memory (207) may store computer program code and/or applications which may be used to instruct/enable the processor (208) to perform functions (e.g. read, write, delete, edit or otherwise process data).

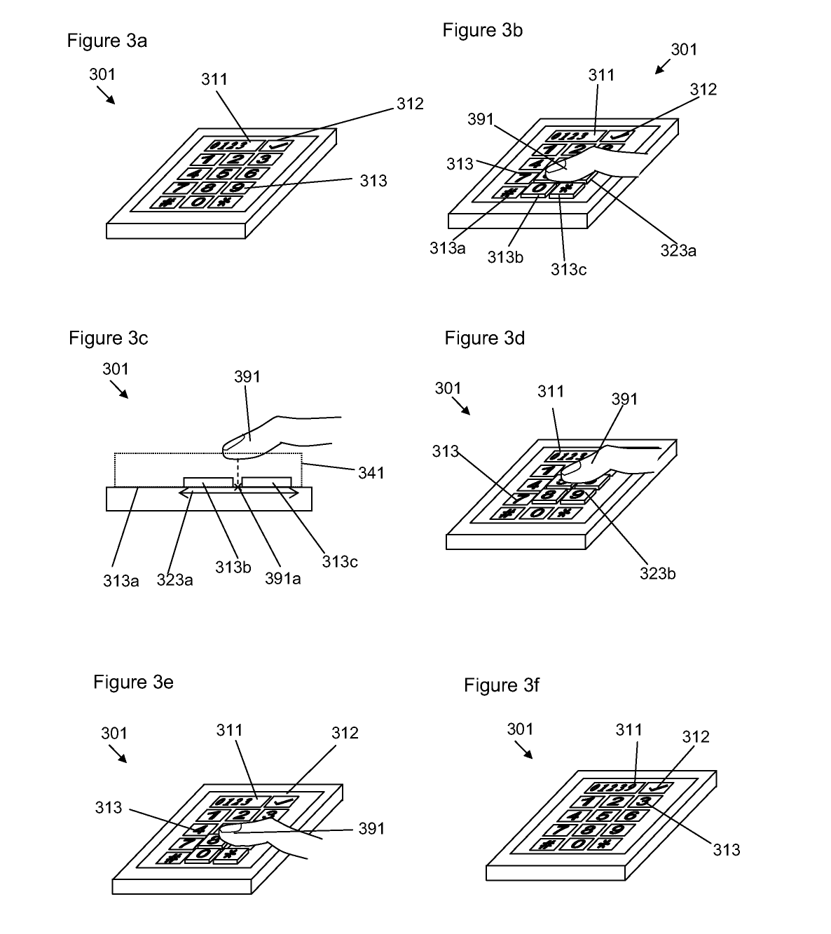

FIG. 3a depicts an example embodiment of the apparatus depicted in FIG. 2 comprising a portable electronic device (301), e.g. such as a mobile phone, with a user interface comprising a touch-screen (305, 304) having a tactile user interface, a memory (not shown), a processor (not shown) and an antenna (not shown) for transmitting and/or receiving data (e.g. emails, textual messages, phone calls, information corresponding to web pages). In this case, the touch screen tactile user interface comprises an array of haptic elements which are independently movable to make shapes on the surface.

FIGS. 3a-f illustrates a series of views of the example embodiment of FIG. 3a when the mobile phone device (301) is in use. The user has entered a telephone mode. In the telephone mode, the user interface comprises: a numeric keypad tactile user interface (313) comprising user interface elements corresponding to numeric characters ‘0’ to ‘9’ and the characters ‘#’ and ‘*’; an entered character region (311) configured to display the number entered by the user; and an initiate call icon (312) enabling the user to initiate a call to the entered number. In other embodiments, a text entry mode may be entered so, for example, a QWERTY keyboard may be provided for use.

In this example the user wishes to enter a number comprising the characters ‘01239’. In this case, the screen (304) is configured to detect objects within a hover range of the screen. That is, this embodiment is configured to recognise if an object (such as a finger or other stylus) is within a predetermined distance from the surface of the screen.

In the situation depicted FIG. 3a, the user has already entered the number ‘0123’ into the entered character region (311). In this situation, the user is not interacting with the screen (304, 305) and so the numeric keypad tactile user interface region (313) is in a first configuration. In this case, in the first configuration, the numeric keypad tactile user interface (313) comprises two-dimensional user interface elements (i.e. the depth aspect is zero). This means that the tactile user interface is flat as the buttons are not raised or lowered with respect to the screen (304, 305) surface. In this case, the pixels corresponding to the two-dimensional user interface elements are configured to be coloured to allow the user to recognise them as user interface elements (e.g. before providing any input via the touch screen interface).

This example embodiment is configured to, in response to detecting the particular non-selecting user input spatially associated with a tactile user interface of an electronic device, the apparatus/embodiment is configured to change or provide for change of a region (323a) of the numeric keyboard tactile user interface (313) from a first configuration to a second configuration, wherein, when the tactile user interface region is in the second configuration, the user interface elements of the tactile user interface region have a different (in this case greater) depth aspect than when the tactile user interface region is in the first configuration. In this case, the numeric keyboard tactile user interface (313) comprises a plurality of regions (323a, 323b), each region being a portion (e.g. a subdivision) of the tactile user interface (313) and being associated with a respective non-selecting user input. That is, the tactile user interface which is changed from a first configuration to a second configuration is dependent on the position of the respective non-selecting user input detected.

In this case, the position of the changed tactile user interface region corresponds to the position of the detected non-selecting user input. It will be appreciated that for other example embodiments, a region of the tactile user interface may comprise the entire tactile user interface. In this case, the non-selecting user inputs are hover non-selecting user inputs, each hover non-selecting user input being provided by placing a stylus (such as a finger) within a hover range of the touch screen tactile user interface, but not touching the touch screen tactile user interface. It will be appreciated that for other example embodiments, a non-selecting user input may comprise a touch user input, wherein an object is in contact or touching the tactile user interface.

In this situation illustrated in FIG. 3b and FIG. 3c (which are a perspective view and a corresponding cross-section view respectively), the user has brought a stylus (which, in this case, is the user's finger (391)) within the hover detection range (341) of the tactile user interface (304, 305) at a particular position with respect to the tactile user interface thereby providing a particular non-selecting user input via the touch screen tactile user interface. The non-selecting user input position is, in this case, defined in terms of the position (391a) on the tactile user interface directly underlying the hover non-selecting user input. In response to detecting the particular non-selecting user input spatially associated with a tactile user interface of an electronic device, the apparatus/embodiment is configured to change the region (323a) of the numeric keyboard tactile user interface with a position corresponding to the position (391a) of the non-selecting user input from a first configuration to a second configuration, wherein, when the tactile user interface region is in the second configuration, the user interface elements of the tactile user interface region have a different depth aspect than when the tactile user interface region is in the first configuration. The user interface elements in a second configuration are raised up above the plane of the screen to have a greater depth aspect compared to the user interface elements in the first configuration. By being raised up, it will be appreciated that the user may be able to see and/or to feel more easily where the positions of the user interface elements are.

In this case non-selecting user input may be considered to be an input which is not associated with a command relating to the content (e.g. entering the number) corresponding to a user interface element. That is, in this case, a non-selecting user input may be considered to not allow the user enter the corresponding character into the entered character region.

In this case, the changed tactile user-interface region (323a) has a predetermined area, comprising user interface elements within a predetermined range of the non-selecting user input position. In the situation depicted in FIG. 3b, the tactile user interface region corresponding to the particular user input comprises the user interface elements corresponding to the numbers ‘8’, ‘9’, ‘0’ (313b) and ‘*’ (313c) as these user interface elements are within the predetermined range (e.g. 1-2 cm) of the position of the non-interacting user input. For this embodiment, the user interface elements which are not part of the tactile user interface region corresponding to the particular user input are not changed and remain in the first configuration (for example, the user interface element corresponding to the character ‘#’ (313a)).

FIG. 3d depicts the situation where the user has moved his finger (391) to provide a different particular hover non-selecting user input. In this case, the hover non-selecting user input is provided above the intersection between the characters ‘5’, ‘6’, ‘8’ and ‘9’. The corresponding tactile user interface region (323b) is centred on this position and has a predetermined area such that the user interface elements within a predetermined range of the non-selecting user input are configured to be changed into a second configuration by being raised above the plane of the screen. In response to detecting a different hover non-selecting user input (the previous non-selecting user input being depicted in FIGS. 3b and 3c), the user interface elements corresponding to the characters ‘0’ (313b) and ‘*’ (313c) are changed from being in a (three-dimensional) second configuration to being in a (two-dimensional) first configuration. In this case, the tactile user interface region is configured to remain in a second configuration whilst the corresponding particular non-selecting user input is ongoing. It will be appreciated that, for other example embodiments, the tactile user interface region may be configured to remain in a second configuration for a pre-determined period of time (e.g. 1-5 seconds) after detecting the corresponding particular non-selecting user input.

In this case, the user wishes to enter the number ‘9’ into the entered character region. The user therefore provides a selecting user input by pressing on the three-dimensional ‘9’ user interface element (as depicted in FIG. 3e), the pressing possibly moving the user interface element ‘9’ to a first configuration. For this example embodiment, the tactile user interface region corresponding to a particular non-selecting user input is configured to remain in a second configuration when a selecting input is detected after the particular non-selecting user input. Therefore, as shown in FIG. 3e, after the user presses on the three-dimensional ‘9’ user interface element (which is a selecting user input), the region corresponding to the previously detected non-selecting user input remains in a second configuration for the duration of the selecting user input (rather than returning to a first configuration). This selects the corresponding numeric character which is then entered into the entered character region (depicted in FIG. 3f). This embodiment is configured to, in response to not detecting a new user input associated with the tactile user interface (e.g. after 5-10 seconds), change the tactile user interface region from a (three-dimensional) second configuration to a (two-dimensional) first configuration. As, in the situation depicted in FIG. 3f (but with the finger/stylus not shown for clarity), no new user input is detected (despite the presence of the stylus (not shown)), the tactile user interface regions have been changed to a first configuration.

It will be appreciated that, for other example embodiments, in the first configuration, the user interface elements may be configured to be de-activated so as not to detect selecting user input, and in the second configuration, the user interface elements may be configured to be activated so as to be able to detect selecting user input.

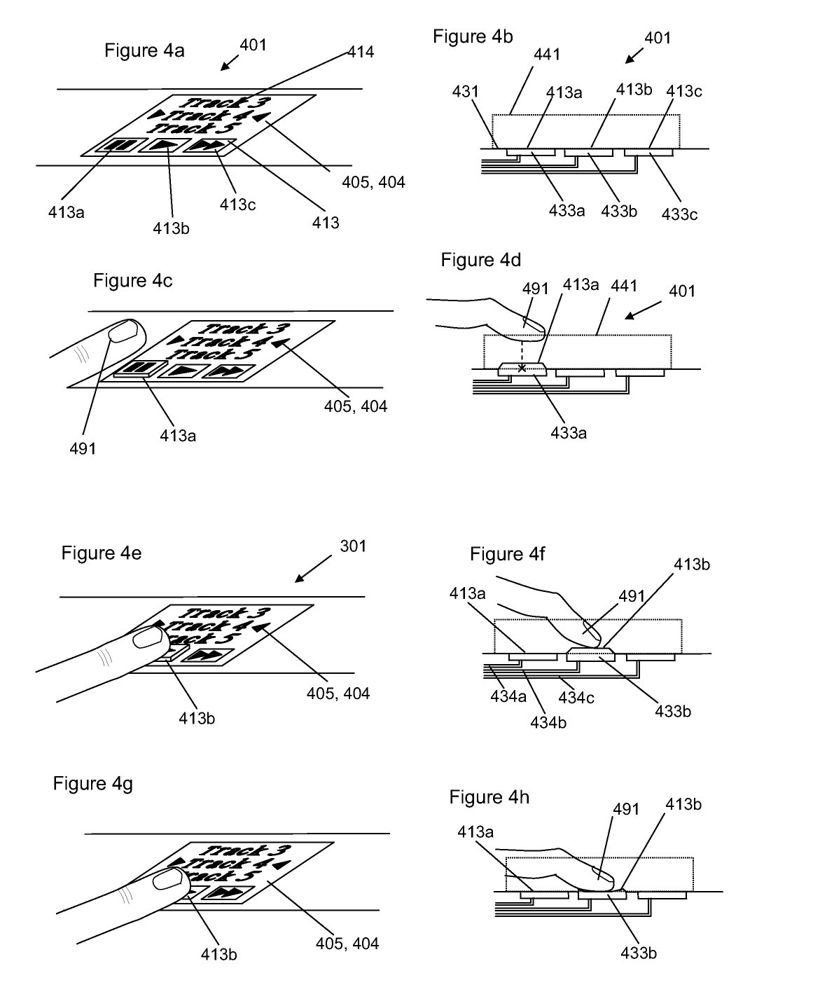

FIG. 4a and FIG. 4b depicts, in a perspective and a cross-section view respectively, a further example embodiment comprising an electronic device (401), e.g. such as an in-car entertainment system, with a user interface comprising a touch-screen tactile user interface (405, 404). In this case the tactile user interface comprises a resilient layer (431), underneath which there are chambers (433a, 433b, 433c) corresponding to user interface elements (413a, 413b, 413c). By introducing fluid (e.g. gas or liquid) into a chamber (433a, 433b, 433c) the overlying resilient layer (431) extends outwards producing a three-dimensional user interface element (413a, 413b, 413c) with a greater depth aspect. When fluid is removed from the chamber (433a, 433b, 433c) the overlying resilient layer (431) lies in the same plane as the surrounding surface resulting in a user interface element (413a, 413b, 413c) having no depth (e.g. a two-dimensional user interface element). Unlike the previous embodiment which was configured to change the configuration of the tactile user interface region in response to hover non-selecting user input, this embodiment is configured to change the configuration of the tactile user interface region in response to hover non-selecting user input and in response to touch non-selecting user input.

FIGS. 4a-h illustrate a series of views of the example embodiment of FIG. 4a when the electronic device (201) is in use. The electronic device is in a music player mode. In the music player mode, the user interface comprises: an icon tactile user interface region (431) comprising user interface elements corresponding to the commands, ‘pause’ (413a), ‘play’ (413b) and ‘skip track’ (413c); and track list region (414) configured to display a list of audio tracks (e.g. mp3 files). In the situation depicted in FIGS. 4a and 4b, the user is not interacting with (e.g. providing input to) the tactile user interface (413).

In this example, the user wishes to select the ‘play’ user interface element (413b) in order to play the selected track which in this case is ‘track 4’. In this case, the screen is configured to detect objects within a hover range of the tactile user interface. That is, this embodiment is configured to recognise if an object (such as a finger or other stylus) is within a predetermined distance from the surface of the tactile user interface (413). It will be appreciated that some example embodiments may be configured to detect only some objects (e.g. a user's finger) but not others.

In the situation depicted in FIG. 4a and FIG. 4b, the user is not interacting with the screen and so the tactile user interface (413) is in a first configuration. That is, in the first configuration, the icon tactile user interface region comprises two-dimensional user interface elements having no depth (413a, 413b, 413c). This means that the tactile user interface is flat as the buttons are not raised or lowered with respect to the tactile user interface surface.

In FIGS. 4c and FIG. 4d (corresponding to a perspective view and a cross-second view respectively), the user has brought a stylus (in this case, the user's finger (491)) within the hover detection range (441) of the tactile user interface thereby providing a non-selecting user input. In response to detecting the particular hover non-selecting user input spatially associated with a tactile user interface of an electronic device, the apparatus/embodiment is configured to change a corresponding (positionally with respect to the position of the hover non-selecting user input) region of the numeric keyboard tactile user interface region from a first configuration to a second configuration, wherein, when the tactile user interface region is in the second configuration, the user interface elements of the tactile user interface region have a different (greater) depth aspect than when the tactile user interface region is in the first configuration. In this case, the area delimited by the boundary of each user interface element is a region of the tactile user interface. That is, in this case, the user interface regions are configured to be mutually exclusive so that one user interface element is provided in the second configuration at one time. It will be appreciated that, for other embodiments, user interface regions may be overlapping. If a non-selecting user input is detected within a region of the tactile user interface (either in contact with or directly above the user interface element) the corresponding user interface element is changed from a first configuration to a second configuration by introducing fluid into the underlying chamber (via a pipe/channel (334a, 334b, 334c)).

In this case, only the one or more user interface element corresponding to the particular non-selecting user input is configured to be changed. In the situation depicted in FIGS. 4c and 4d, the ‘pause’ user interface element (413a) is changed to a second configuration as the ‘pause’ user interface element (413a) underlies the detected particular non-interacting user input. In this case, the user interface elements are configured to be in a second configuration by being raised above the plane of the touch screen user interface, such that the user interface elements have a greater depth aspect. By being raised up, it will be appreciated that the user may be able to see better precisely where the position of the user interface elements are.

FIGS. 4e and 4f (corresponding to a perspective view and a cross-section view respectively) depicts the situation where the user has moved his finger to provide a contact non-selecting user input. In this case, the contact non-selecting user input is provided within the tactile user interface region corresponding to the ‘play’ user interface element (413b). In response to the particular contact non-selecting user input, the corresponding ‘play’ user interface element (413b) is configured to be changed to a second configuration from a first configuration by being raised above the plane of the screen. In this case, as the previously detected non-selecting user input (depicted in FIGS. 4c and 4d) is no longer detected within the ‘pause’ tactile user interface region, the ‘pause’ user interface element (413a) has been changed from a (three-dimensional) second configuration to a (two-dimensional) first configuration. It will be appreciated that, for other example embodiments, the one or more user interface element of a tactile user interface region in a second configuration may be configured to remain in a second configuration for a pre-determined period of time (e.g. 5-10 seconds) after the corresponding particular non-selecting user input has ceased.

The user in this case wishes to select the ‘play’ user interface element in order to play the corresponding selected audio track. The user therefore provides a selecting user input by pressing on the (three-dimensional) ‘play’ user interface element (413b) (as depicted in FIGS. 4g and 4h). The apparatus in this case is configured to detect a selecting user input by detecting an increase in pressure associated with depressing the three-dimensional user interface element. In this way, the user interface elements are only configured to be active (i.e. selectable) when in a second configuration. That is, in the first configuration, the user interface elements are configured to be de-activated so as not to detect selecting user input, and in the second configuration, the user interface elements are configured to be activated so as to be able to detect selecting user input. It will be appreciated that other example embodiments may be configured such that the user interface elements are activated both in the first configuration and in the second configuration.

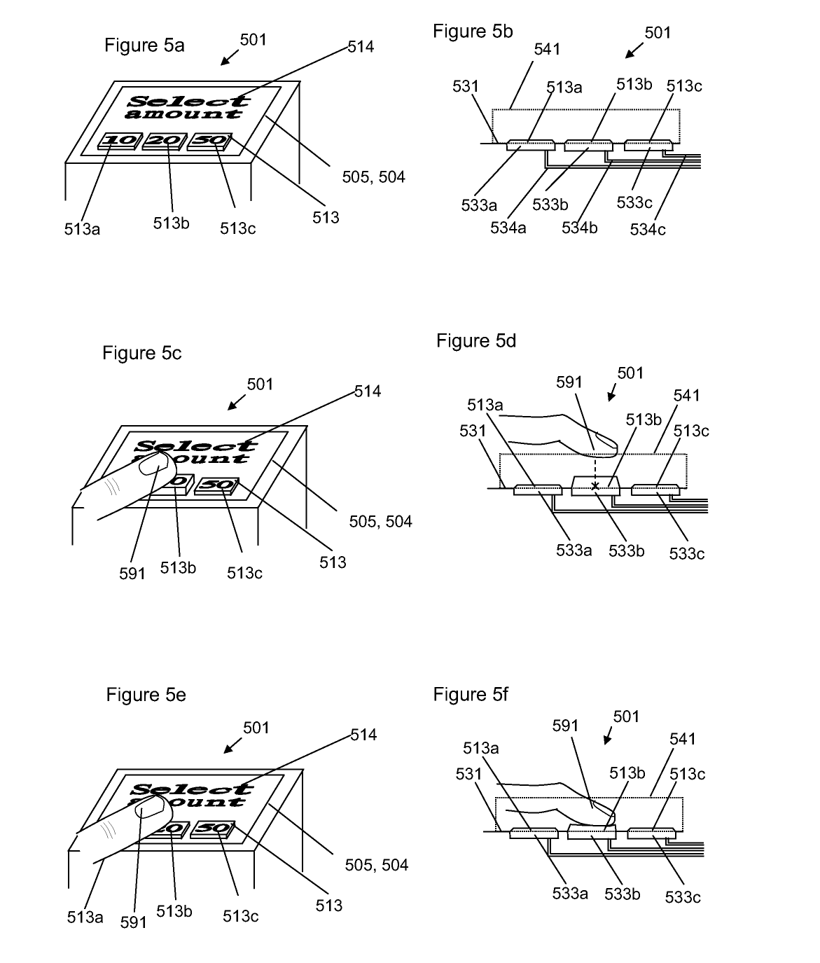

FIG. 5a and FIG. 5b depicts, in a perspective and a cross-section view respectively, a further example embodiment comprising an electronic device (501), e.g. such as an cash machine, with a user interface comprising a touch-screen tactile user interface (505, 504). In this case the tactile user interface comprises a resilient layer (531), underneath which there are chambers (533a, 533b, 533c) corresponding to user interface elements (513a, 513b, 513c). By introducing fluid (e.g. gas or liquid) into a chamber (533a, 533b, 533c) the overlying resilient layer (531) extends outwards producing a user interface element with a relatively large depth aspect (513a, 513b, 513c). When fluid is removed from the chamber (533a, 533b, 533c) the overlying resilient layer (531) lies in the same plane as the surrounding surface resulting in a user interface element with a relatively small depth aspect (513a, 513b, 513c). That is, unlike the previous embodiments, the user interface elements are configured to be three-dimensional in the first configuration, as well as in the second configuration.

Like the previous embodiment, this embodiment is configured to change the configuration of the tactile user interface region in response to hover non-selecting user input and in response to touch non-selecting user input.

FIGS. 5a-f illustrate a series of views of the example embodiment of FIG. 5a when the electronic device (201) is in use. In the situation depicted in FIG. 5a, the user interface comprises: an icon tactile user interface region (531) comprising user interface elements corresponding to the commands, ‘10’ (513a), ‘20’ (513b) and ‘50’ (513c) corresponding to amounts of money which can be requested from the cash machine; and an information region (514) configured to instruct the user. In the situation depicted in FIGS. 5a and 5b, the user is not interacting with (e.g. providing input to) the tactile user interface (513).

In this example, the user wishes to select the ‘20’ user interface element (513b) in order to request £20 from the cash machine. In this case, the screen is configured to detect objects within a hover range of the tactile user interface. That is, this embodiment is configured to recognise if an object (such as a finger or other stylus) is within a predetermined distance from the surface of the tactile user interface (513). It will be appreciated that some example embodiments may be configured to detect only some objects (e.g. a user's finger) but not others.

In the situation depicted in FIG. 5a and FIG. 5b, the user is not interacting with the screen and so the tactile user interface (513) is in a first configuration. That is, in the first configuration, the icon tactile user interface region comprises user interface elements having a first depth (513a, 513b, 513c).

In FIG. 5c and FIG. 5d (corresponding to a perspective view and a cross-second view respectively), the user has brought a stylus (in this case, the user's finger (591)) within the hover detection range (541) of the tactile user interface thereby providing a non-selecting user input. In response to detecting the particular hover non-selecting user input spatially associated with a tactile user interface of an electronic device, the apparatus/embodiment is configured to change a corresponding (positionally with respect to the position of the hover non-selecting user input) region of the tactile user interface region from a first configuration to a second configuration, wherein, in the second configuration, the tactile user interface region comprises the same user interface element in a second configuration. In this case, the area delimited by the boundary of each user interface element is a region of the tactile user interface. That is, in this case, the user interface regions are configured to be mutually exclusive so that one user interface element is provided in the second configuration at one time. It will be appreciated that, for other embodiments, user interface regions may be overlapping. If a non-selecting user input is detected within a region of the tactile user interface (either in contact with or directly above the user interface element) the corresponding user interface element is changed from a first configuration to a second configuration by introducing fluid into the underlying chamber (via a pipe/channel (534a, 534b, 534c)) which increases the depth of the changed user interface element.

In this case, only the one or more user interface element corresponding to the particular non-selecting user input is configured to be changed. In the situation depicted in FIGS. 5c and 5d, the ‘20’ user interface element (513a) is changed to a second configuration as the ‘20’ user interface element (513a) underlies the detected particular non-interacting user input.

The user in this case wishes to select the ‘20’ user interface element in order to request £20. The user therefore provides a selecting user input by pressing on the increased depth ‘20’ user interface element (513b) (as depicted in FIGS. 5e and 5f). The apparatus in this case is configured to detect a selecting user input by detecting an increase in pressure associated with depressing the three-dimensional user interface element. In this way, the user interface elements are only configured to be active (i.e. selectable) when in a second configuration. That is, in the first configurations, the user interface elements are configured to be de-activated so as not to detect selecting user input, and in the second configuration, the user interface elements are configured to be activated so as to be able to detect selecting user input. It will be appreciated that other example embodiments may be configured such that the user interface elements are activated both in the first configuration and in the second configuration.

In the above described embodiments, the region of the tactile user interface which is changed in response to each respective particular non-selecting user input represents a portion, or a subset, of the user interface elements making up the tactile user interface. Changing only a portion of the tactile user interface from a first configuration to a second configuration may extend the life of the screen as only those user interface elements which are desired may be activated. It will be appreciated that in other example embodiments, all of the user interface elements may be changed from a first configuration to a second configuration in response to a particular non-selecting user input.

It will be appreciated that other example embodiments may be configured such that the depth aspect of a particular user interface element is related to the position of the non-selecting user input. For example, user interface elements closer to the non-selecting user input may have a greater depth aspect to user interface elements further away from the non-selecting user input.

In the above described embodiments, the user interface elements are configured to be above the surface in the second configuration. It will be appreciated that other example embodiments may have a depth aspect such that the user interface elements are configured to be below the display surface in the first/second configuration.

In the above described embodiments, the tactile user interface forms part of a display. It will be appreciated that for other example embodiments the tactile user interface may not form part of a display. For example, an embodiment may be a control panel (e.g. for a heating system or music player) having a tactile user interface but not having a display, or a remote controller (e.g. for a television) having a key tactile user interface without a display.

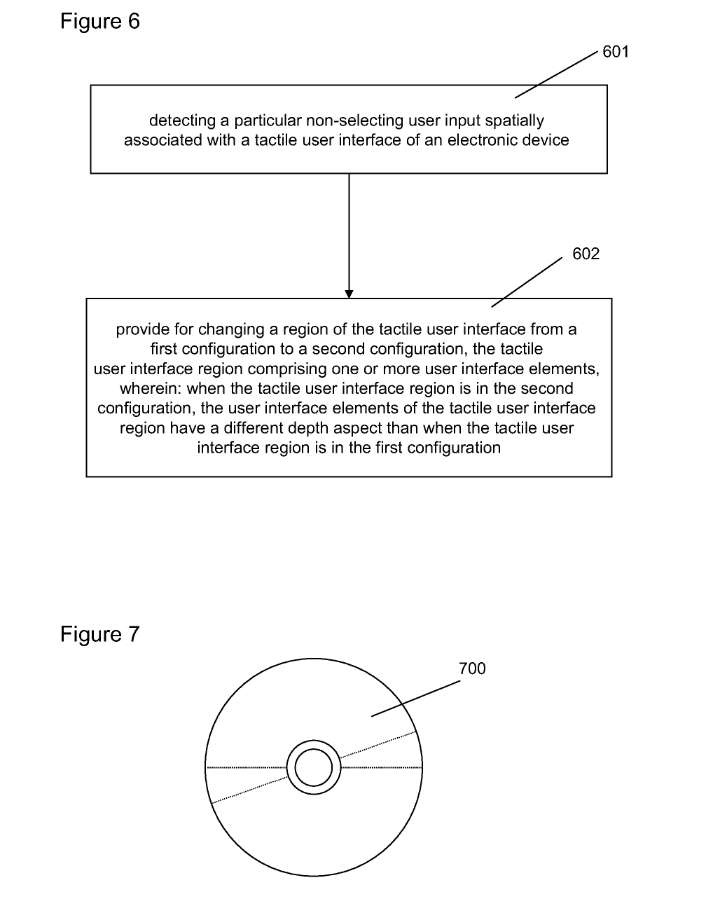

FIG. 6 shows a flow diagram illustrating changing the tactile user interface region from a first configuration to a second configuration, and is self-explanatory.

FIG. 7 illustrates schematically an embodiment comprising a computer/processor readable media 700 providing a computer program. In this example, the computer/processor readable media is a disc such as a digital versatile disc (DVD) or a compact disc (CD). In other embodiments, the computer readable media may be any media that has been programmed in such a way as to carry out an inventive function.

It will be appreciated to the skilled reader that any mentioned apparatus/device and/or other features of particular mentioned apparatus/device may be provided by apparatus arranged such that they become configured to carry out the desired operations only when enabled, e.g. switched on, or the like. In such cases, they may not necessarily have the appropriate software loaded into the active memory in the non-enabled (e.g. switched off state) and only load the appropriate software in the enabled (e.g. on state). The apparatus may comprise hardware circuitry and/or firmware. The apparatus may comprise software loaded onto memory. Such software/computer programs may be recorded on the same memory/processor/functional units and/or on one or more memories/processors/functional units.

In some embodiments, a particular mentioned apparatus/device may be pre-programmed with the appropriate software to carry out desired operations, and wherein the appropriate software can be enabled for use by a user downloading a “key”, for example, to unlock/enable the software and its associated functionality. Advantages associated with such embodiments can include a reduced requirement to download data when further functionality is required for a device, and this can be useful in examples where a device is perceived to have sufficient capacity to store such pre-programmed software for functionality that may not be enabled by a user.

It will be appreciated that the any mentioned apparatus/circuitry/elements/processor may have other functions in addition to the mentioned functions, and that these functions may be performed by the same apparatus/circuitry/elements/processor. One or more disclosed aspects may encompass the electronic distribution of associated computer programs and computer programs (which may be source/transport encoded) recorded on an appropriate carrier (e.g. memory, signal).

It will be appreciated that any “computer” described herein can comprise a collection of one or more individual processors/processing elements that may or may not be located on the same circuit board, or the same region/position of a circuit board or even the same device. In some embodiments one or more of any mentioned processors may be distributed over a plurality of devices. The same or different processor/processing elements may perform one or more functions described herein.

With reference to any discussion of any mentioned computer and/or processor and memory (e.g. including ROM, CD-ROM etc), these may comprise a computer processor, Application Specific Integrated Circuit (ASIC), field-programmable gate array (FPGA), and/or other hardware components that have been programmed in such a way to carry out the inventive function.

The applicant hereby discloses in isolation each individual feature described herein and any combination of two or more such features, to the extent that such features or combinations are capable of being carried out based on the present specification as a whole, in the light of the common general knowledge of a person skilled in the art, irrespective of whether such features or combinations of features solve any problems disclosed herein, and without limitation to the scope of the claims. The applicant indicates that the disclosed aspects/embodiments may consist of any such individual feature or combination of features. In view of the foregoing description it will be evident to a person skilled in the art that various modifications may be made within the scope of the disclosure.

While there have been shown and described and pointed out fundamental novel features of the invention as applied to preferred embodiments thereof, it will be understood that various omissions and substitutions and changes in the form and details of the devices and methods described may be made by those skilled in the art without departing from the scope of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. Furthermore, in the claims means-plus-function clauses are intended to cover the structures described herein as performing the recited function and not only structural equivalents, but also equivalent structures. Thus although a nail and a screw may not be structural equivalents in that a nail employs a cylindrical surface to secure wooden parts together, whereas a screw employs a helical surface, in the environment of fastening wooden parts, a nail and a screw may be equivalent structures.

1. An apparatus comprising:
at least one processor; and
at least one memory including computer program code,
the at least one memory and the computer program code configured to, with the at least one processor, cause the apparatus to perform at least the following:
in response to detecting a particular non-selecting user input spatially associated with a tactile user interface of an electronic device, provide for changing a region of the tactile user interface from a first configuration to a second configuration, the tactile user interface region comprising one or more user interface elements, wherein:
when the tactile user interface region is in the second configuration, the user interface elements of the tactile user interface region have a different depth aspect than when the tactile user interface region is in the first configuration.

2. The apparatus of claim 1 wherein,
in the first configuration, the user interface elements comprise two-dimensional user interface elements, and
in the second configuration, the user interface elements comprise three-dimensional user interface elements.

3. The apparatus of claim 1, wherein the user interface elements of the tactile user interface region have a greater depth aspect in the second configuration than when the tactile user interface region is in the first configuration.

4. The apparatus of claim 1, wherein only one or more user interface elements underlying the non-selecting user input are configured to be changed to the second configuration, the non-underlying regions of the user interface remaining in the first configuration.

5. The apparatus of claim 1, wherein the apparatus is configured to:
in response to the position of the non-selecting user input changing, correspondingly change the position of the three-dimensional tactile user interface region.

6. The apparatus of claim 1, wherein the non-selecting user input is a user input provided without touching the tactile user interface.

7. The apparatus of claim 1, wherein a position of the tactile user interface corresponding to the position of the non-selecting user input is activated from a deactivated state upon detecting the particular non-selecting input.

8. The apparatus of claim 1, wherein,
in the first configuration, the user interface elements are configured to be de-activated so as not to detect selecting user input, and
in the second configuration, the user interface elements are configured to be activated so as to be able to detect selecting user input.

9. The apparatus of claim 1, wherein the apparatus is configured to provide for change of the user interface elements from the second configuration to the first configuration after a predetermined period of time if a selecting user input has not been detected for the predetermined period of time after the non-selecting user input.

10. The apparatus of claim 1, wherein the tactile user interface region is configured to remain in a second configuration whilst the non-selecting user input is detected to be ongoing.

11. The apparatus of claim 1, wherein the tactile user interface region is configured to remain in a second configuration whilst an interaction with the tactile user interface region is detected.

12. The apparatus of claim 1, wherein the apparatus is configured to:
recognise a particular user input maintained for a time period below a predetermined time threshold as a non-selecting user input; and
recognise the same particular user input maintained for a time period exceeding the predetermined time threshold as a selecting user input for the user interface element underlying the position of the particular user input.

13. The apparatus of claim 1, wherein the tactile user interface comprises deformable regions underlying the surface which can be expanded or contracted to change the configuration of the user interface elements between the first configuration and the second configuration.

14. The apparatus of claim 1, wherein the tactile user interface comprises an array of haptic elements which are independently movable to make shapes on the surface to provide for a respective array of user interface elements.

15. The apparatus of claim 1, wherein the apparatus is configured to provide for change between the first configuration and the second configuration using one of electrostatic surface actuation and one or more actuators.

16. The apparatus of claim 1, wherein the apparatus is configured to enable detection of the particular non-selecting user input.

17. The apparatus of claim 1, wherein the apparatus is or forms part of at least one of the electronic device, a portable electronic device, circuitry for a portable electronic device, a television, a tablet computer, a laptop computer, a desktop computer, a mobile phone, a Smartphone, a tablet PC, a monitor, a car entertainment system, a satellite navigation system, a car dashboard, a remote control, a control panel, a game controller, an automated teller machine, a cash machine, a personal digital assistant, a digital camera or a module for the same.

18. The apparatus of claim 1, wherein the apparatus comprises a display, user interface elements, a user interface of a display, or wherein the tactile user interface forms part of a display.

19. A method, the method comprising:
in response to detecting a particular non-selecting user input spatially associated with a tactile user interface of an electronic device, providing for changing a region of the tactile user interface from a first configuration to a second configuration, wherein:
when the tactile user interface region is in the second configuration, the user interface elements of the tactile user interface region have a different depth aspect than when the tactile user interface region is in the first configuration.

20. A computer program comprising computer program code configured to:
in response to detecting a particular non-selecting user input spatially associated with a tactile user interface of an electronic device, provide for changing a region of the tactile user interface from a first configuration to a second configuration, wherein:
when the tactile user interface region is in the second configuration, the user interface elements of the tactile user interface region have a different depth aspect than when the tactile user interface region is in the first configuration.
